(19) United States
(12) Patent Application Publication
(10) Pub. No.: US 2009/0236153 A1
(43) Pub. Date: Sep. 24, 2009

(54) ELECTRONIC SENSORY PEN AND METHOD FOR INPUTTING/OUTPUTTING SENSORY INFORMATION USING THE SAME

(76) Inventors: Ki-Uk Kyung, Daejon (KR); Jun-Seok Park, Daejon (KR); Ji-Eun Park, Seoul (KR); Jun-Young Lee, Daejon (KR); Myung-Gyu Kim, Daejon (KR); Ji-Yeon Son, Daejon (KR); Il-Sik Yang, Daejon (KR); Yong-Hee Lee, Daejon (KR); Dong-Won Han, Daejon (KR)

Correspondence Address: LADAS & PARRY LLP, 224 SOUTH MICHIGAN AVENUE, SUITE 1600, CHICAGO, IL, 60604, US

(21) Appl. No.: 12/439,186

(22) PCT Filed: Aug. 23, 2007
(86) PCT No.: PCT/KR2007/004032

§ 371 Date: Feb. 27, 2009

(30) Foreign Application Priority Data
Sep. 1, 2006 (KR) 10-2006-0084354

(51) Int. Cl. G06F 3/033; G08B 6/00; G01D 21/00

(52) U.S. Cl. 178/19.01; 340/407.2; 116/214

(57) ABSTRACT

Provided are an electronic pen for inputting/outputting sensory information and a method for recognizing taste information and transforming the taste information into smell information using the same. The electronic pen includes: a sensory information input unit for receiving sensory information of the object; a signal processing unit for processing and storing sensory information transmitted from the sensory information input unit; a sensory information reproducing unit for outputting the sensory information; and a wireless communication unit for transmitting the sensory information.

### TECHNICAL FIELD

The present invention relates to an electronic pen for inputting/outputting sensory information and a method for recognizing taste information and transforming the taste information into smell information using the electronic pen; and, more particularly, to a sensory information inputting/outputting electronic pen which can input and store diverse information such as text, pattern, icon, texture, and a sense of heat, and output sensory information in the form of vibration and temperature through a sensory information reproducing unit, or transform taste information into smell information and transmit and output the smell information, and a method for outputting smell information using the electronic pen.

### BACKGROUND ART

Conventional electronic pens can be used only for a mobile communication terminal, or give a vibration feedback. Therefore, there is a problem that the conventional electronic pens cannot institutionally transmit and share diverse information through a mobile terminal capable of measuring and reproducing touch, smell and taste information.

### DISCLOSURE OF INVENTION

### Technical Problem

An embodiment of the present invention is directed to providing a sensory information input/output electronic pen which can be consistently used with no regard to the kind and exchange of a terminal and transmit sensory information specifically and institutionally by embedding a module capable of inputting/outputting senses of touch, smell and taste into an electronic pen, which is a pen-type input device generally used in a mobile communication terminal.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an electronic pen for inputting/outputting sensory information in contact with an object, including: a sensory information input unit for receiving sensory information of the object; a signal processing unit for processing and storing sensory information transmitted from the sensory information input unit; a sensory information reproducing unit for outputting the sensory information; and a wireless communication unit for transmitting the sensory information.

In accordance with another aspect of the present invention, there is provided an electronic pen for inputting/outputting sensory information, including: a head part including a sensory information input unit for contacting an object and receiving sensory information of the object, a signal processing unit for processing and storing the inputted sensory information, and a first connector; and a body part including a second connector connected to the first connector and receiving the inputted sensory information, a driving unit for driving a driving module based on the sensory information, a control board connected to the second connector and controlling an electric driving module, a sense reproducing unit for outputting the sensory information through the driving unit and the control board, and a wireless communication unit.

In accordance with another aspect of the present invention, there is provided an electronic pen for inputting/outputting sensory information, including: a head part including an electronic tongue for generating sensory information according to a quantity of a component related to taste, a signal processing unit for processing and storing the sensory information inputted from the electronic tongue, and a first connector; and a body part including a second connector connected to the first connector and receiving the sensory information, a driving unit for driving a driving module based on the sensory information, a control board connected to the second connector and controlling an electric driving module, a fragrance emitting unit for outputting sensory information through the driving unit and the control board, and a wireless communication unit.

In accordance with another aspect of the present invention, there is provided a method for outputting smell information with a sensory information input/output electronic pen, including the steps of: a) measuring taste characteristics of an object with an electronic tongue of the sensory information input/output electronic pen; b) storing the measured taste characteristics as taste data through a signal processing unit and a taste analyzing unit; c) spraying a smell substance based on a control board.

### ADVANTAGEOUS EFFECTS

The electronic pen of the present invention can be consistently used with no regard to the kind and exchange of a terminal and transmit sensory information specifically and intuitively by embedding a module capable of inputting/outputting senses of touch, smell and taste into the electronic pen, which is a pen-type input device generally used in a mobile communication terminal. Also, the electronic pen of the present invention can store and restore information related to the senses of touch, smell and taste in a daily life as well as for a mobile terminal.

### BRIEF DESCRIPTION OF THE DRAWINGS

FIG. 1 shows an example that the sensory information input/output electronic pen according to the present invention is used.

FIG. 2 shows the sensory information input/output electronic pen in accordance with the embodiment of the present invention.

FIG. 3 shows a head part of the sensory information input/output electronic pen in accordance with a first embodiment of the present invention.

FIG. 4 shows a body part of the sensory information input/output electronic pen in accordance with the embodiment of the present invention.

FIG. 5 shows a pin operation of the sensory information input/output electronic pen in accordance with the embodiment of the present invention.

FIG. 6 shows another example that the sensory information input/output electronic pen according to the present invention is used.

FIG. 7 shows another example that the sensory information input/output electronic pen according to the present invention is used.

FIG. 8 shows a head part of the electronic pen in accordance with a second embodiment of the present invention.

FIG. 9 describes a method for recognizing taste information in the sensory information input/output electronic pen and transmitting and outputting the taste information in the form of smell information in accordance with an embodiment of the present invention.

### BEST MODE FOR CARRYING OUT THE INVENTION

Other objects and advantages of the present invention will become apparent from the following description of the embodiments with reference to the accompanying drawings. Therefore, those skilled in the field of this art of the present invention can embody the technological concept and scope of the invention easily.

Configurations, functions and effects of a sensory information input/output electronic pen and a smell information output method using the electronic pen in accordance with an embodiment of the present invention will be described in detail hereinafter.

FIG. 1 shows an example that the sensory information input/output electronic pen according to the present invention is used.

While a user uses a mobile communication terminal 200, sensory information related to the sense of touch is transmitted to a wireless communication unit 125 and an antenna of a sensory information input/output electronic pen 100 through a wireless communication unit 210 of the terminal. Also, a plurality of pins 122 of an electronic pen 100 transmit the sense of touch to a finger holding a pen based on sensory information.

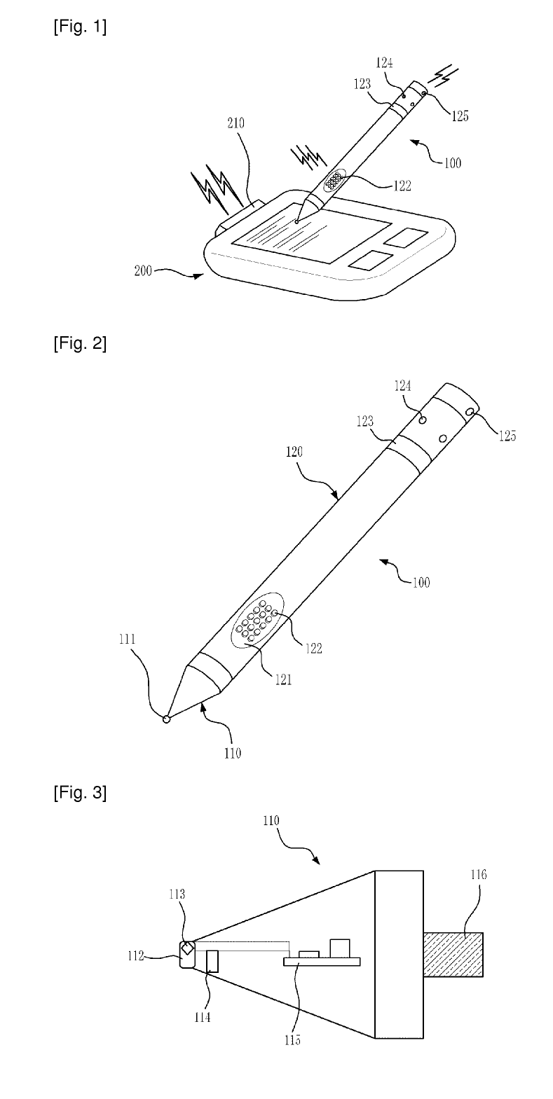

FIG. 2 shows the sensory information input/output electronic pen in accordance with the embodiment of the present invention.

The electronic pen 100 includes the head part 110 and a body part 120. The end of the head part includes a tip 111 for contacting with an information detection object, a mobile communication terminal and a display unit. The body part 120 includes a groove 121, a plurality of pins 122, a heat-radiating plate 123, an inlet 124, a wireless communication unit 125, and a smell substance outlet 144 (not shown in FIG. 2).

The tip 111 contacts the mobile communication terminal 200 or the outside. The groove 121 is formed on a perimeter of the body. An opening, which the pin is movably inserted into, is formed. A plurality of pins are arranged to directly give an impetus with displacement perpendicularly to the skin of the finger. The heat-radiating plate 123 radiates heat generated in an internal circuit of the electronic pen. An external air flows into the inlet 124. The wireless communication unit 125 communicates with an external terminal or another electronic pen. The smell substance outlet 144 pushes out a smell substance to an opposite end of the head part.

A structure of the sensory information input/output electronic pen head part will be described in detail.

As shown in FIG. 3, the head part of the sensory information input/output electronic pen includes a tip including a pressure sensor 112 and a temperature sensor 113, a signal processor 115 and a first connector 116.

When the tip 111 of the electronic pen 100 contacts with a mobile communication terminal or an external environment, the micromini-sized three-axis pressure sensor 112 measures contact force and can determine whether the tip 111 contacts the mobile communication terminal or the external environment. Also, the micromini-sized threeaxis pressure sensor 112 can measure a moving direction and power of the tip 111 while the tip 111 slices on the contacted surface in a contact state such as operations of writing or drawing a pattern or an icon. The pressure sensor is formed in a film type and it is formed of piezoelectric polymer such as polyvinylidenefluoride (PVDF). Also, it is preferred to measure the temperature of the surface, which is contacted to the tip 111, by embedding the temperature sensor 113 including a thermo couple in the tip 111. However, a resistance temperature detector (RTD) also can be used to measure the temperature of the surface. The motion of the electronic pen is measured by embedding a three-axis acceleration sensor 114 in a part close to the tip 111.

The signal processor 115 processes sensory information inputted in the tip 111 and the first connector 116 is combined with the body.

All of the sensory information acquired in the tip 111 of the head part are transmitted to the first connector 116 through the signal processor 115 in the inside of the head part and the first connector 116 is connected to a second connector 143 in the body part 120 of the electronic pen.

A structure of the body of the sensory information input/output electronic pen will be described in detail.

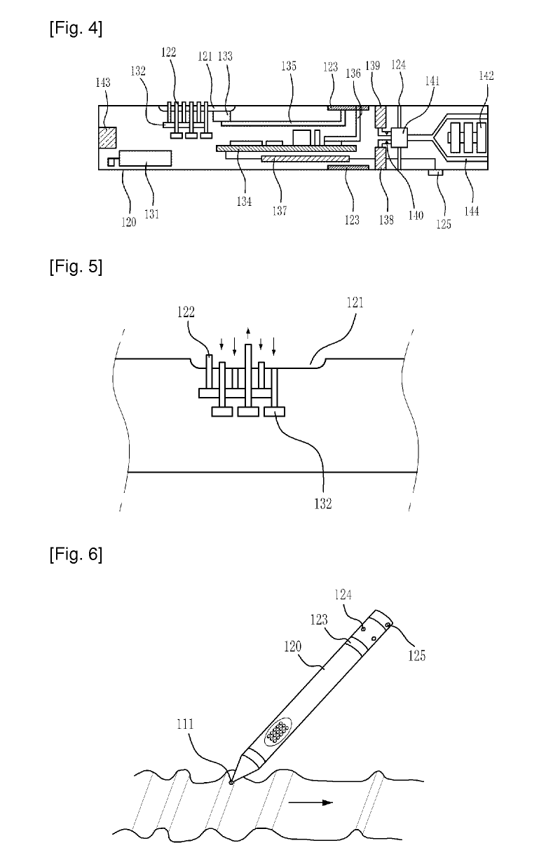

As shown in FIG. 4, the body part 120 of the sensory information input/output electronic pen includes the second connector 143, the groove 121, a plurality of pins 122, a micromini-sized motor 132, a vibration motor 131, a heat-absorbing/radiating unit 133, a control board 134, the wireless communication unit 125, a heat pipe 135, the heat-radiating cover 135, smell substance storing tanks 138 and 139, an electronic micro pump 141, the inlet 124, a nozzle 140, and a power source 142.

The second connector 143 is electronically connected to the first connector 116 of the head part 110 and receives the inputted sensory information. The groove 121 is formed on a perimeter of the body and an opening is formed. The pins 122 stimulate the skin of the contacting finger through the motion of the perpendicular direction. The small linear motor 132 induces linear movement of a pin. The vibration motor 131 transmits vibration to the hand holding the body by vibrating itself. The heat-absorbing/radiating unit 133 transmits the sense of cold and warmth to the skin of the finger contacting the groove. The control board 134 controls all electronic drive devices in the inside. The wireless communication unit 125 wirelessly communicates with the outside. The heat pipe 135 radiates the heat generated in the heat-absorbing/radiating unit and the control board. The heat-radiating plate 123 radiates the heat transmitted from the heat pipe 135 to the outside of the electronic pen. The smell substance storing tanks 138 and 139 store the smell substance. The electronic micro pump 141 generates a pressure difference to eject out the smell substance to the outside. The inlet 124 is formed to inflow external air. The nozzle 140 sprays smell substance to the outside by the pressure difference generated from the pump. The power source 142 supplies power to all electronic devices inside.

The second connector 143 has electronic combination with the electronic pen head simultaneously happening with mechanical combination. Also, the second connector 143 is connected to the control board 134 and leads the control board 134 to transmit a signal incoming from a sensor of the tip 111.

The groove is formed on an external surface of the body such that a finger can touch. Also, the groove 121 is formed of a metal plate having high conductivity such as copper. A device capable of absorbing/radiating heat is attached to the inside of the body. The device is formed of Peltier s cell and can transmit both senses of cold and warmth to the skin contacting with the metal plate through current control.

A plurality of pins 122 are distributed on a plane to respectively transmit stimulation to the skin. The pins can move in a vertical direction. The pins 122 are arranged such that the user can feel the texture of materials such as a pattern of the surface and roughness when the pins 122 and directly transformed by the skin through height and speed of each pin.

In the embodiment of the present invention, it is preferred that a plurality of pins 122 are densely arranged to transmit minute stimulation to the skin when the pins are embedded in the electronic pen. Herein, a micromini-sized linear ultrasonic motor, which can be operated at low voltage, is used. However, it is possible to substitute the micromini-sized linear ultrasonic motor for a solenoid or a voice coil driver by those skilled in the art.

The operation of the pin 122 is electronically controlled and connected to the control board 134 through a circuit. Since information can be transmitted to the user based on vibration information, the vibration motor 131 embedded in the electronic pen is connected to the control board 134. It is preferred to use an eccentric motor of a general cylinder type as the vibration motor 131. However, a pancake motor also can be used.

The control board 134 includes a processor, a memory, a current voltage amplifier, analog input/output units, and digital input/output units and controls all functional devices inside.

In the present invention, it is preferred to use a Bluetooth module in the communication unit between the electronic pen and the mobile communication terminal or between the electronic pens. However, wireless communication modules such as Transmission Control Protocol/Internet Protocol (TCP/IP), User Datagram Protocol (UDP) and Radio Frequency (RF) can be used.

Each of the smell substance storing tanks 138 and 139 includes many tanks and stores fragrances of camphor, musk, fragrance, mint, alcohol, and coffee. A kind of fragrances can be diversely realized by those skilled in the art.

The nozzle 140 controls the quantity of smell substance radiated in each tank. As shown in FIG. 4, the tank is located in a place where the smell substance can be easily recharged.

The electronic micro pump 141 draws in air through an external inlet, mixes the smell substance with gas, and sprays mixture gas to the smell substance outlet 144 at the end of the electronic pen, which is located in a nearest direction from the nose.

FIG. 5 shows a pin operation of the sensory information input/output electronic pen in accordance with the embodiment of the present invention.

As shown in FIG. 5, the array of the pin 122 is operated in a vertical direction and directly stimulates the skin. Since a small linear motor has a limited size, the motors are crossly arrayed such that the pins can be densely embedded. It is preferred to design an interval between the pins within 1 mm to suggest the texture in detail and more accurately.

The pins 122 may be individually controlled. Accordingly, when the surface is uneven, it is possible to transmit uneven feeling to the skin by individually moving each pin within a proper range.

FIG. 6 shows another example that the sensory information input/output electronic pen according to the present invention is used.

The sensory information input/output electronic pen may be used to rub the surface in a daily life as well as on a touch screen of a mobile communication terminal or a computer according to the present invention. The pressure sensor 112 embedded in the tip 111 of the electronic pen measures whether there is any contact on the surface. The pressure sensor 112 measures the hardness degree of the surface. While the electronic pen is used, the posture and motion of the electronic pen by the user are limited within a predetermined range. The projection degree of the surface can be measured by measuring the minute vertical direction motion of the tip 111 generated by the motion of the electronic pen end on the plane and the design of the surface by using the acceleration sensor 114 embedded in the head part 110 of the electronic pen. All of the measured data are stored through the signal processor 115. At the same time, the temperature of the surface is measured and stored through the temperature sensor 113.

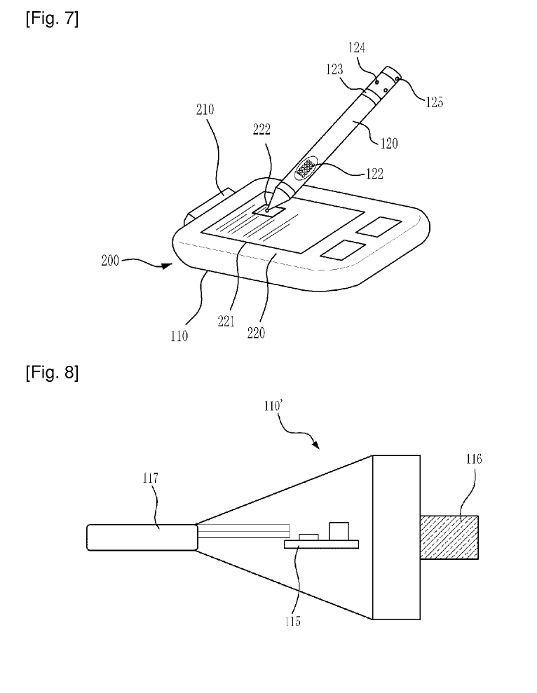

FIG. 7 shows another example that the sensory information input/output electronic pen according to the present invention is used.

As shown in FIG. 7, the mobile communication terminal 200 includes the wireless communication unit 210 and the display unit 220. The display unit 220 displays a projection degree of minute particles on the surface according to the location, the senses of cold and warmth, pattern with texture storing material information, and icons.

The user transmits a pattern with its texture, a pattern which can be changed according to the press location when an icon 221 is rubbed, and texture information of a region 222 on the icon to the wireless communication unit 125 of the sensory information input/output electronic pen 100 through the wireless communication unit 210 of the mobile communication terminal.

The transmitted information on the texture shows the projection degree of the surface through pin 122 and the stimulation is transmitted to the finger. The minute projection information of the surface, which may not be expressed by the pins 122, is expressed through vibration of the vibration motor 131.

As the second embodiment of the present invention, the sensory information input/output electronic pen includes the head part 110 and the body part 120. The head part 110 includes an electronic tongue 117 for generating sensory information according to the quantity of a component related to the taste and the signal processor 115 for processing and storing sensory information inputted from an electronic tongue and the first connector 116. The body part 120 includes the second connector 143 for being connected to the first connector and receiving the inputted sensory information, a driving module for driving electricity based on the sensory information, the control board 134 for being connected to the first connector and controlling the electric driving module, a sense reproducing unit for outputting sensory information through the driving module and the control board, and the wireless communication unit 125.

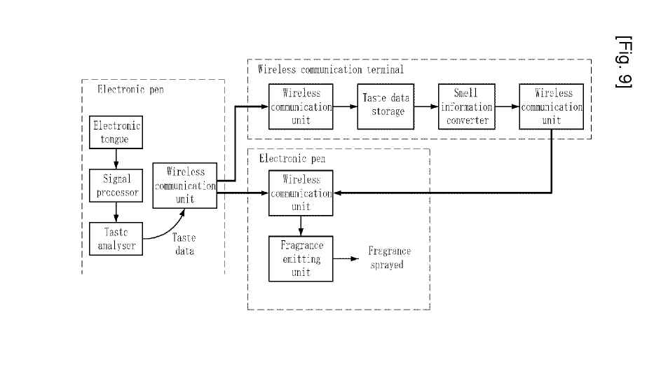

FIG. 8 shows a head part of the electronic pen including the electronic tongue for analyzing taste of a material in the sensory information input/output electronic pen in accordance with a second embodiment of the present invention.

The head part includes the electronic tongue 117, the signal processor 115, and the first connector 116. As shown in FIG. 8, the electronic tongue 117 is a portable chemical material analyzer for measuring components and concentration of alcoholic and nonalcoholic drinks, and storing and transmitting the information in the pen. The electronic tongue 117 generates sensory information according to the quantity of the component related to taste. The signal processor 115 processes the inputted sensory information and the first connector 116 is combined with the body part 120.

The head part 110 of the electronic pen 100 can be exchanged with another head part including the electronic tongue 117 for generating electronic sensory information according to the quantity of the component related to taste, the signal processor 115 for processing the inputted sensory information, and the first connector 116 to be combined with the body part of the electronic pen. The electronic tongues for measuring strength of bitter taste, salty taste, sour taste, and alcohol are commercialized by some companies. The electronic tongue can be embedded in the inside of the electronic pen. The electronic tongue can be exchanged with a sensor for measuring diverse tastes. The strength of the measured taste is transmitted to the body part of the electronic pen and stored. The first connector 116 combined with the body part of the electronic pen is formed in the same manner as the first connector 116 described in FIG. 3 is formed. The first connector 116 is designed to be exchanged according to use purpose.

FIG. 9 describes a method for recognizing taste information based on the sensory information input/output electronic pen and transmitting and outputting the taste information as smell information in accordance with an embodiment of the present invention. The taste information measured by the electronic tongue 117 is stored as taste data through a signal processor and the taste analyzer and outputted as smell information through the fragrance emitting unit. Also, the taste data are transmitted to the mobile communication terminal through a wireless communication unit and transmitted to another sensory information input/output electronic pen through a smell information transformer when the other party wants.

The transmitted data are transformed and sprayed into a smell substance through the fragrance emitting unit. The transmitted data may be directly transmitted to another electronic pen without going through the terminal of the data. Herein, the transmitted data goes through the smell information transformer in the inside of other electronic pen. The smell information transformer determines smell of corresponding food from the analyzed taste. The smell information transformer selects the smell substance of the smell substance storing tank and outputs a control value of the nozzle. As an example, when the electronic tongue is soaked in strong coffee, the taste analyzer analyzes the strong coffee as the coffee having a strong bitter taste and the smell information transformer analyzes the strong coffee as the coffee having strong fragrance. The electronic tongue leads the data transmitted to the electronic pen to be sprayed through the control board by high pressure by widely opening the nozzle of the coffee fragrance storing tank in the fragrance emitting unit.

The present application contains subject matter related to Korean Patent Application No. 2006-0084354, filed in the Korean Intellectual Property Office on Sep. 1, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. An electronic pen for inputting/outputting sensory information in contact with an object, comprising:
a sensory information input unit for receiving sensory information of the object;
a signal processing unit for processing and storing sensory information transmitted from the sensory information input unit;
a sensory information reproducing unit for outputting the sensory information; and
a wireless communication unit for transmitting the sensory information.

2. An electronic pen for inputting/outputting sensory information, comprising:
a head part including a sensory information input unit for contacting an object and receiving sensory information of the object, a signal processing unit for processing and storing the inputted sensory information, and a first connector; and
a body part including a second connector connected to the first connector and receiving the inputted sensory information, a driving unit for driving a driving module based on the sensory information, a control board connected to the second connector and controlling an electric driving module, a sense reproducing unit for outputting the sensory information through the driving unit and the control board, and a wireless communication unit.

3. The electronic pen of claim 2, wherein the sensory information input unit includes a pressure sensor, a temperature sensor, and an acceleration sensor for measuring motion of the pen.

4. The electronic pen of claim 2, wherein the sense reproducing unit includes a groove formed to have an opening on a perimeter of the body, and a pin inserted into the opening of the groove to transmit stimulation to a contacted finger; and
the driving unit includes a micromini-sized motor for linearly operating the pin and a vibration motor for transferring vibration to a hand holding the pen.

5. The electronic pen of claim 2, wherein the body further includes:
a heat-absorbing/radiating unit for transmitting a sense of cold or warmth,
a communication unit for wirelessly communicating with outside,
an antenna,
a heat pipe for outputting heat generated in the heat-absorbing/radiating unit and the control board to the outside,
a heat-radiating plate for radiating the heat transmitted from the heat pipe to the outside of the pen,
a smell substance storing tank, an electronic micro pump for generating a pressure difference to spray the smell substance to the outside,
an inlet for inflowing air from the outside,
a spray nozzle for spraying the smell substance to the outside by the pressure difference caused in the pump, and
a power source for supplying power to the electronic device in the inside of the body.

6. The electronic pen of claim 4, wherein the pin includes a plurality of element pins are distributed on a plane to directly apply stimulus with displacement to the finger in a vertical direction.

7. The electronic pen of claim 4, wherein the groove includes a metal plate having high conductivity, and a device capable of absorbing/radiating heat is attached to the other side of the groove.

8. The electronic pen of claim 2, wherein the control board includes a processor, a memory, a current voltage amplifier, analog input and output units, and a digital input/output units.

9. An electronic pen for inputting/outputting sensory information, comprising:
a head part including an electronic tongue for generating sensory information according to a quantity of a component related to taste, a signal processing unit for processing and storing the sensory information inputted from the electronic tongue, and a first connector; and
a body part including a second connector connected to the first connector and receiving the sensory information, a driving unit for driving a driving module based on the sensory information, a control board connected to the second connector and controlling an electric driving module, a fragrance emitting unit for outputting the sensory information through the driving unit and the control board, and a wireless communication unit.

10. The electronic pen of claim 9, wherein the fragrance emitting unit includes a taste analyzer for analyzing taste, a smell substance storing tank, an air inlet, a spray nozzle and a pump.

11. A method for outputting smell information with a sensory information input/output electronic pen having an electronic tongue, a signal processing unit, a taste analyzing unit, a control board, a smell substance storing tank, an air inlet, and a spray nozzle and a pump, comprising the steps of:
a) measuring taste characteristics of an object with the electronic tongue of the sensory information input/output electronic pen;
b) storing the measured taste characteristics as taste data through the signal processing unit and the taste analyzing unit; and
c) spraying a smell substance based on the control board through the smell substance storing tank, the air inlet, the spray nozzle and the pump.

12. The method of claim 11, further comprising the steps of:
d) transmitting the stored taste data to a mobile communication terminal through a wireless communication unit;
e) storing the taste data in the mobile communication terminal;
f) transmitting the taste data from the mobile communication terminal to another sensory information input/output electronic pen; and
g) spraying a smell substance from the sensory information input/output electronic pen based on the control board through the smell substance storing tank, the air inlet, the spray nozzle and the pump.

13. The method of claim 11, further comprising the steps of:
h) transmitting the stored taste data to another sensory information input/output electronic pen; and
i) spraying a smell substance corresponding to the transmitted taste data through a fragrance emitting unit in the sensory information input/output electronic pen.
